(19) United States
(12) Patent Application Publication
(10) Pub. No.: US 2026/0148009 A1
(43) Pub. Date: May 28, 2026

(54) Prompt Generation for Dynamic Contextual Suggestion

(71) Applicant: Google LLC, Mountain View, CA (US)

(72) Inventors: Luis Carlos Dos Santos Marujo, Mountain View, CA (US); Jeff Joseph Nainaparampil, New York, NY (US); Maryam Karimzadehgan, Portola Valley, CA (US); Kalyana Ram Desineni, San Jose, CA (US)

(73) Assignee: Google LLC, Mountain View, CA (US)

(21) Appl. No.: 18/960,336

(22) Filed: Nov. 26, 2024

(51) Int. Cl. G06F 40/40

(52) U.S. Cl. CPC G06F 40/40

(57) ABSTRACT

This document describes systems and techniques directed at prompt generation for dynamic contextual suggestions. An electronic device accesses interaction data. A suggestion prompt generator of the electronic device receives the interaction data and determines, at least in part from a context of the interaction data, a domain. In some examples, the suggestion prompt generator applies a filter to the interaction data based on the domain. The suggestion prompt generator generates a prompt for a Large Language Model (LLM). The prompt is configured to cause the LLM to generate a suggestion based on the interaction data, the context, or the domain. The suggestion prompt generator receives a suggestion from the LLM and, in some cases, applies the filter to the suggestion. The suggestion prompt generator then outputs the suggestion to a display element.

### BACKGROUND

Users of electronic devices can greatly benefit from digital assistants, including those leveraging functionality of applications (apps) and/or capabilities of electronic devices. The promulgation of artificial intelligence (AI), particularly large language models, allows digital assistants to parse natural language, thus improving user experience, immersion, and the overall functionality of the electronic device. The functionality of digital assistants, however, is hampered when needing context and content from a user. Without this context and content, the digital assistant may struggle to give helpful suggestions to the user.

### SUMMARY

This document describes systems and techniques directed at prompt generation for dynamic contextual suggestions. An electronic device accesses interaction data. A suggestion prompt generator of the electronic device receives the interaction data and determines, at least in part from a context of the interaction data, a domain. In some examples, the suggestion prompt generator applies a filter to the interaction data based on the domain. The suggestion prompt generator generates a prompt for a large language model (LLM). The prompt configured to cause the LLM to generate a suggestion based on the interaction data, the context, or the domain. The suggestion prompt generator receives a suggestion from the LLM and, in some cases, applies the filter to the suggestion. The suggestion prompt generator then outputs the suggestion, for example to a display element.

In aspects, an electronic device is disclosed, the electronic device including one or more processors and a memory. The memory stores instructions that, when accessed by the one or more processors, cause the one or more processors to receive interaction data, the interaction data configured to be output to the electronic device and comprising a context. The instructions further cause the one or more processors to select, based on at least one of the interaction data and the context, a domain from among a plurality of available domains and to generate, based on at least one of the interaction data, the context, and the domain, a suggestion prompt configured to be an input to a suggestion large language model (LLM).

In aspects, a method is disclosed that includes receiving, by one or more processors, interaction data, the interaction data configured to be output to an electronic device and comprising a context. The method further includes selecting, by the one or more processors and based on at least one of the interaction data and the context, a domain from among a plurality of available domains and generating, by the one or more processors and based on at least one of the interaction data, the context, and the domain, a suggestion prompt configured to be an input to a suggestion LLM.

In aspects, a non-transitory, computer-readable medium is disclosed, the non-transitory, computer-readable medium including instructions that, when accessed by one or more processors, cause the one or more processors to receive interaction data, the interaction data configured to be output to an electronic device and comprising a context. The instructions further cause the one or more processors to select, based on at least one of the interaction data and the context, a domain from among a plurality of available domains and to generate, based on at least one of the interaction data, the context, and the domain, a suggestion prompt configured to be an input to a suggestion LLM.

In aspects, a computer programming product is disclosed, the computer programming product including a memory storing instructions that, when accessed by one or more processors, cause the one or more processors to receive interaction data, the interaction data configured to be output to an electronic device and comprising a context. The instructions further cause the one or more processors to select, based on at least one of the interaction data and the context, a domain from among a plurality of available domains and to generate, based on at least one of the interaction data, the context, and the domain, a suggestion prompt configured to be an input to a suggestion LLM.

This Summary is provided to introduce simplified concepts for prompt generation for dynamic contextual suggestions, which is further described below in the Detailed Description and is illustrated in the Drawings. This Summary is intended neither to identify essential features of the claimed subject matter nor for use in determining the scope of the claimed subject matter.

### BRIEF DESCRIPTION OF THE DRAWINGS

The details of one or more aspects of systems and techniques for prompt generation for dynamic contextual suggestions are described in this document with reference to the following drawings:

FIG. 1 illustrates an example environment in which techniques for prompt generation for dynamic contextual suggestions can be implemented;

FIG. 2 illustrates an example environment in which techniques for prompt generation for dynamic contextual suggestions can be implemented;

FIG. 3 illustrates an example of a computing device of FIGS. 1 and 2 for implementing prompt generation for dynamic contextual suggestions;

FIG. 4 illustrates an example block diagram directed at implementing prompt generation for dynamic contextual suggestions;

FIG. 5 illustrates an example block diagram directed at implementing aspects of dynamic contextual suggestions;

FIG. 6 illustrates examples of domains of FIG. 1 used in prompt generation for dynamic contextual suggestions;

FIG. 7 illustrates examples of a safety of FIG. 1 for prompt generation for dynamic contextual suggestions;

FIG. 8 illustrates an example trainer for an LLM, such as one used in prompt generation for dynamic contextual suggestions;

FIG. 9 illustrates an example transformation in a language space of an input tensor component;

FIG. 10 illustrates a fine-tuning (FT) trainer;

FIG. 11 illustrates an example low-rank adaptation training for an LLM; and

FIG. 12 illustrates an example method for prompt generation for dynamic contextual suggestions.

The use of same numbers in different instances may indicate similar features or components.

### DETAILED DESCRIPTION

### Overview

The promulgation of artificial intelligence (AI), particularly large language models (LLMs), has revolutionized personal digital assistance. Particularly, the realm of AI suggestions has become far more robust and useful to end users. LLMs allow for natural language processing (NLP), for example parsing input queries and formatting output suggestions. However, there is still a human component required in the initial query. For instance, consider a user interacting with an electronic device (e.g., a smart phone). The user may look at a display of the smart phone and the information contained therein, for example a conversation, an internet search, a shopping application, etc. The user may invoke an AI assistant and ask for a suggestion based on the information. For example, if the user is having a conversation with a friend and the conversation contains information on going out to eat together, the user can invoke the AI assistant and ask for lunch suggestions based on the conversation.

The act of the user invoking the AI assistant, or otherwise requiring a user interaction component, lessens the utility of AI assistant suggestions. In one example, a user does not invoke the AI assistant and thus misses out on receiving potentially useful AI suggestions. In another example, the AI assistant is invoked and asked for suggestions, but the user does not provide all of the relevant information and thus the suggestions are suboptimal. Removal of the user interaction component (e.g., invoking the AI assistant) improves the functionality of AI suggestions by allowing the AI to parse the information with which the user is interacting and automatically offer suggestions.

This document describes techniques and systems for prompt generation for dynamic contextual suggestions. The techniques and systems use a suggestion prompt generator, which interacts with interaction data to generate a suggestion prompt for a suggestion LLM. The suggestion prompt generator may run in real-time and on-device, further enhancing the user experience by allowing for faster suggestion generation. The suggestion prompt generator may account for relevant parameters (a context of the interaction data, domains for the interaction data, etc.) used in the suggestion prompt generation, in parsing a suggestion from the suggestion LLM, or both. The techniques provide users with greater usability of both the device and applications installed on the device.

### Operating Environment

The following discussion describes operating environments, techniques that may be employed in the operating environments, and various devices or systems in which components of the operating environments can be embodied. In the context of the present disclosure, reference is made to the operating environments by way of example only.

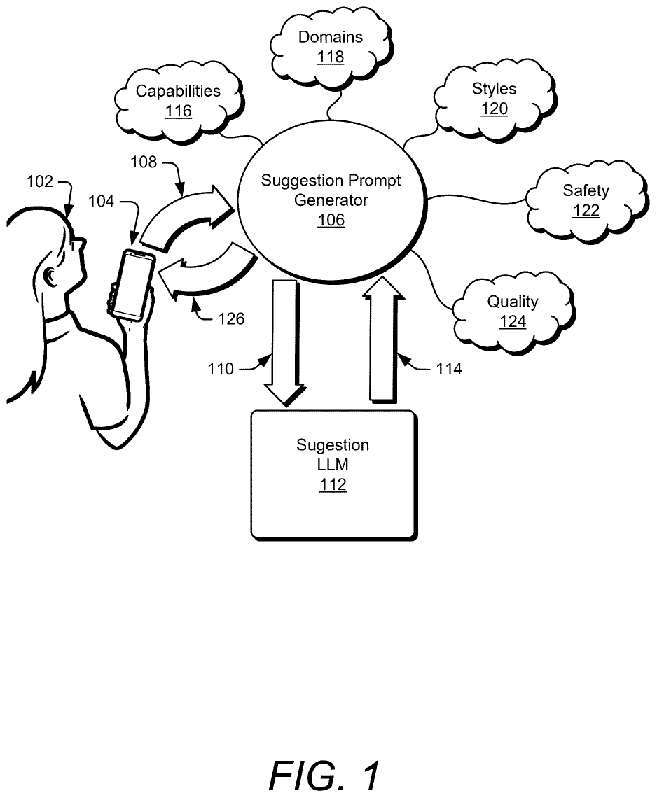

FIG. 1 illustrates an example environment 100 in which techniques for prompt generation for dynamic contextual suggestions can be implemented. Generally, the environment 100 includes a user 102 and a computing device 104. The computing device 104 includes a suggestion prompt generator 106. The suggestion prompt generator 106 receives interaction data 108 from the computing device 104. For example, the interaction data 108 can be from a screen-reader implemented on the computing device 104, data intended to be displayed on the computing device 104, data intended for output to the user 102 (e.g., music or audio output for a pair of wireless earbuds, directions on a smart car interface), etc.

The computing device 104, in some examples, can be an assistant device (e.g., Google® Nest® Hub; Google® Nest® Hub Max), a home automation controller (e.g., controller for an alarm system, thermostat, lighting system, door lock, motorized doors, etc.), a gaming device (e.g., a gaming system, gaming controller, data glove, etc.), a communication device (e.g., a smart phone such as a Google® Pixel® Phone, cellular phone, mobile phone, wireless phone, portable phone, radio telephone, etc.), a wearable device (e.g., smart watch, smart glasses, earbuds, smart helmet, VR headset, AR goggles, smart ring, etc.), a vehicle (car, electric scooter, automated vehicle, etc.), and/or other computing device (e.g., a tablet computer, phablet computer, notebook computer, laptop computer, etc.). As another example, the computing device 104 with an assistant application or program (e.g., the AI assistant) may audibly convey the information to the user 102. In some implementations, a battery management system audibly conveys notification information to the user 102 and lists actions the user 102 may take, such as ordering new batteries or obtaining disposal information. In some implementations, the computing device 104 listens for a response from the user 102, such as a user selection of one or more of the listed actions, and responds accordingly (e.g., obtaining and audibly conveying disposal options to the user 104).

Based on the interaction data 108, the suggestion prompt generator 106 generates a suggestion prompt 110 configured to be input to a suggestion LLM 112. The suggestion LLM 112, in aspects, generates a suggestion 114, which is sent to the suggestion prompt generator 106. In some examples, the suggestion prompt 110 is based on one or more parameters, filters, thresholds, etc. available to the suggestion prompt generator 106. For example, the suggestion prompt generator 106 has access to one or more capabilities 116, domains 118, styles 120, a safety 122 (e.g., a safety filter, one or more safety parameters), and a quality 124 (e.g., a quality filter, a comparison metric). In some examples, the suggestion LLM 112 is stored in a memory of the computing device 104. In other examples, the suggestion LLM 112 is stored on a remote device (not pictured) communicatively coupled to the computing device 104.

In some examples, the suggestion prompt generator 106 is a prompt generation LLM. In other examples, the suggestion prompt generator 106 uses the prompt generation LLM as one component in the generation of the suggestion prompt 110. In some examples, the prompt generation LLM is based on the suggestion LLM 112, an example of which being a low-rank adaptation (LoRA) of the suggestion LLM 112. In some examples, the prompt generation LLM is one of a plurality of available prompt generation LLMs and the suggestion prompt generator 106 selects the prompt generation LLM from among the plurality of available prompt generation LLMs based at least in part on one or more of the interaction data 108, a context of the interaction data 108, or one or more parameters, filters, thresholds, and/or the domains 118. In some examples, the prompt generation LLM is stored in the memory of the computing device 104.

The one or more parameters, filters, thresholds, etc. available to the suggestion prompt generator 106 can be, in some examples, applied to the suggestion prompt 110, the suggestion 114, or both. The one or more parameters may be applied before or after generation of the suggestion prompt 110 and/or the suggestion 114. For example, the suggestion prompt generator 106 can, based on the interaction data 108, select a specific domain from among the domains 118. The specific domain may affect how the suggestion prompt 110 is generated. For example, if the specific domain is a shopping domain, the suggestion prompt 110 can include a request for pricing and purchasing information. In another example where the selected domain is the shopping domain, the suggestion prompt generator 106 can append pricing information to the suggestion 114. In some examples, the selection of the specific domain may include selecting more than one domain from among the domains 118.

Additionally or alternatively, the one or more parameters (e.g., the one or more parameters 116-124), filters, thresholds, etc. available to the suggestion prompt generator 106 can, in some examples, work together for the generation of the suggestion prompt 110, the suggestion 114, or both. For example, consider the suggestion prompt generator 106 determining that the interaction data 108 belongs to a political domain available in the domains 118. The safety 122 may determine that the political domain is a restricted domain. Based on the specific domain being a political domain and the safety 122 classifying the political domain as a restricted domain, the suggestion prompt generator 106 may delete the suggestion prompt 110, ignore the suggestion 114, generate a new suggestion prompt, modify the suggestion 114 and/or the suggestion prompt 110, or take another action.

In another example, consider the suggestion prompt generator 106 determining that the interaction data 108 belongs to a conversation domain. The suggestion prompt generator 106 may also determine a style from among the styles 120 available. The style may be one or more of a conversational style, a formal style, a humorous style, or a custom style. In some examples, the style is based at least in part on the context. For example, the suggestion prompt generator 106 determines that the interaction data 108 is in the conversation domain and has a casual style. The suggestion prompt generator 106 may, based on this determination, generate the suggestion prompt 110 with a request for the suggestion 114 to be in a conversational style, generate the suggestion prompt 110 in a conversational style, modify the suggestion 114 into a conversational style, etc.

In aspects, the suggestion prompt generator 106 configures the suggestion 114 for output to the computing device 104, for example by generating a suggestion output 126. The suggestion output 126 is output to the user 102 using the computing device 104. In some examples, the suggestion output 126 is the suggestion 114. In other examples, the suggestion 114 is parsed by the suggestion prompt generator 106 and modified, in some examples by the one or more parameters 116-124. In another example, the suggestion output 126 is an image output, an audio output, a video output, or a tactile output. In some examples, the suggestion prompt generator 106 determines that the suggestion 114 is restricted or inappropriate and does not generate the suggestion output 126.

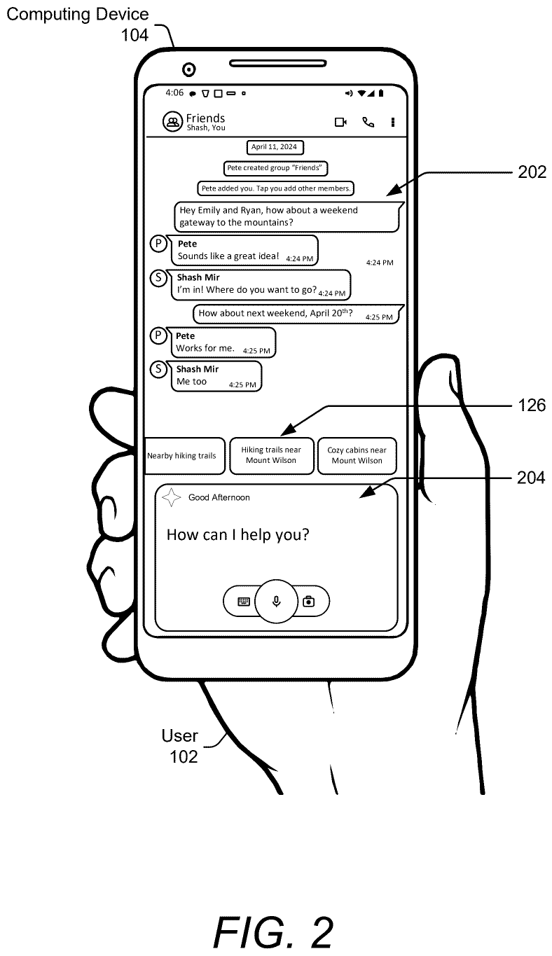

FIG. 2 illustrates an example environment 200 in which techniques for prompt generation for dynamic contextual suggestions can be implemented. The user 102 is holding the computing device 104, in this example a smart phone. The computing device 104 has an instantiated conversation application 202 and an instantiated AI assistant interface 204. The computing device 104 displays a suggestion (e.g., the suggestion 114 of FIG. 1) as the suggestion output 126. As shown in the example suggestion output 126, the suggestion 114 is based on the conversation in the instantiated conversation application 202. In the illustrated example environment 200, the suggestion output 126 includes multiple suggestions from which the user 102 may choose.

In some examples, the suggestion output 126 is generated by a request from the user 102, which can be a query through the instantiated AI assistant interface 204. In other examples, instantiation of the instantiated AI assistant interface 206 triggers a suggestion prompt generator (e.g., the suggestion prompt generator 106 of FIG. 1) to generate a suggestion prompt (e.g., the suggestion prompt 110 of FIG. 1) for a suggestion LLM (e.g., the suggestion LLM 112 of FIG. 1) and to generate the suggestion output 126 based on the suggestion. In other examples, the suggestion output 126 is generated by the suggestion prompt generator 106, as outlined in this disclosure, without any input from the user 102.

Consider the example where the suggestion output 126 is generated by the suggestion prompt generator 106 without any input from the user 102. The suggestion prompt generator 106 can receive the instantiated conversation application 202 as interaction data and determine a context for the interaction data. From this context, the suggestion prompt generator 106 can select a domain from which to generate a suggestion prompt. The suggestion prompt can be an input for the suggestion LLM, the suggestion LLM generating the suggestion. In this example, the suggestion prompt generator 106 can parse all relevant information from the interaction data and offer the user 102 a suggestion via the suggestion output 126 that, in some cases, is superior to a different suggestion from a specific user query.

### Example Devices

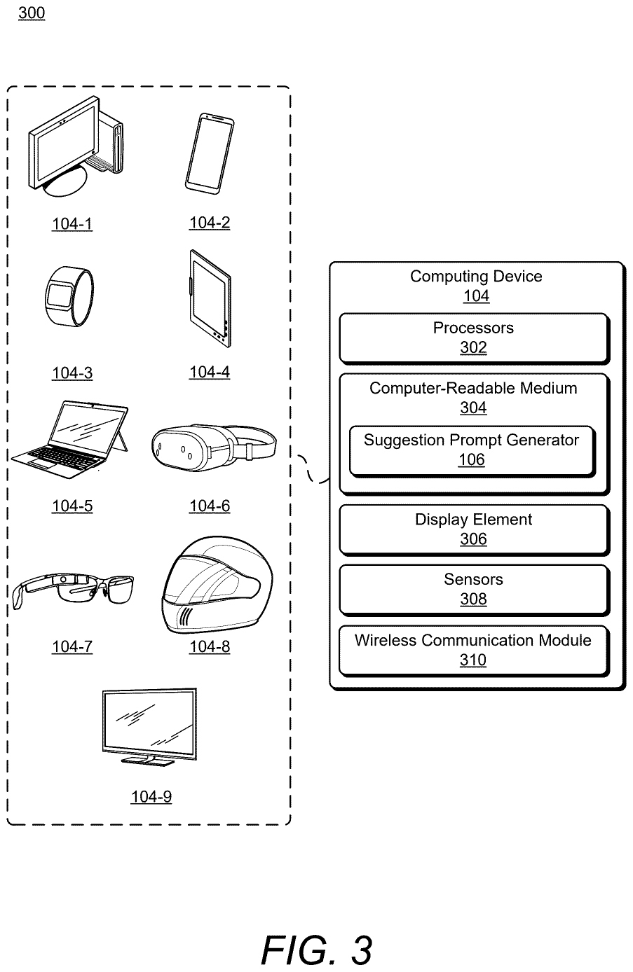

FIG. 3 illustrates an example of the computing device 104 of FIG. 1 for implementing prompt generation for dynamic contextual suggestions. Examples of the computing device 104 include a desktop computer 104-1, a smartphone 104-2, a smartwatch 104-3, a tablet device 104-4, a laptop computer 104-5, VR goggles 104-6, smart-glasses 104-7, a smart-helmet 104-8, and an all-in-one computer 104-9. Although not shown, the computing device 104 may also be implemented as any of a mobile communication device, a client device, a home automation and control system, an entertainment system, a personal media device, a health monitoring device, a drone, a camera, an Internet home appliance capable of wireless Internet access and browsing, an IoT device, security systems, and the like. Note that the computing device 104 can be wearable, non-wearable but mobile, or relatively immobile (e.g., appliances). The computing device 104 may include components or interfaces omitted from FIG. 3 for the sake of clarity or visual brevity.

As illustrated, the computing device 104 includes one or more processors 302 and a computer-readable medium 304 (e.g., a memory). The one or more processors 302 may include any suitable single-core or multi-core processor (an application processor (AP), a digital-signal processor (DSP), a central processing unit (CPU), a graphics processing unit (GPU), etc.). The one or more processors 302 may be configured to execute instructions or commands stored within the computer-readable medium 304. The computer-readable medium 304 may be stored within one or more non-transitory storage devices, for example a random access memory (RAM, dynamic RAM (DRAM), non-volatile RAM (NVRAM), static RAM (SRAM), etc.), a read-only memory (ROM), a flash memory, a hard drive, a solid-state drive (SSD), or any type of media suitable for storing electronic instructions, each coupled with a computer system bus. The term “coupled” may refer to two or more elements that are in direct contact (physically, electrically, magnetically, optically, etc.) or to two or more elements that are not in direct contact with each other but still cooperate and/or interact with each other.

The computing device 104 further includes the suggestion prompt generator 106 stored on the computer-readable medium 304. In some examples, the suggestion prompt generator 106 is only partially stored on the computing device 104 and partially stored on another device (not pictured) communicatively coupled to the computing device 104. The computing device 104 further includes a display element 306 and sensors 308. The display element 306 can, for example, display the suggestion output 126 of FIG. 1. The sensors 308 may include one or more light sensors, a barometer, one or more capacitive sensors, one or more accelerometers, one or more microphones, a radar sensor, an ultrasonic sensor, etc.

The computing device 104 may further include and/or be operatively coupled to a wireless communication module 310. The wireless communication module 310 may enable communication of device data, for example received data, transmitted data, or other information as described herein, and may provide connectivity to one or more networks and other devices connected therewith. Examples of the wireless communication module 310 include near field communications (NFC) transceivers, wireless personal area network (WPAN) radios compliant with various IEEE 902.15 (Bluetooth®) standards, wireless local area network (WLAN) radios compliant with any of various IEEE 902.11 (WiFi®) standards, wireless wide area network (WWAN) (3GPP-compliant) radios for cellular telephony, wireless metropolitan area network (WMAN) radios compliant with various IEEE 902.16 (WiMAX®) standards, infrared (IR) transceivers compliant with an Infrared Data Association (IrDA) protocol, and wired local area network (LAN) Ethernet transceivers. Device data communicated over the wireless communication module 310 may be packetized or framed depending on a communication protocol or standard by which the computing device 104 is communicating. The wireless communication module 310 may include interfaces for communication over a local network, a private network, an intranet, the Internet, or wireless networks (e.g., WLANs, cellular networks, or WPANs).

### Example Suggestion Prompt Generation

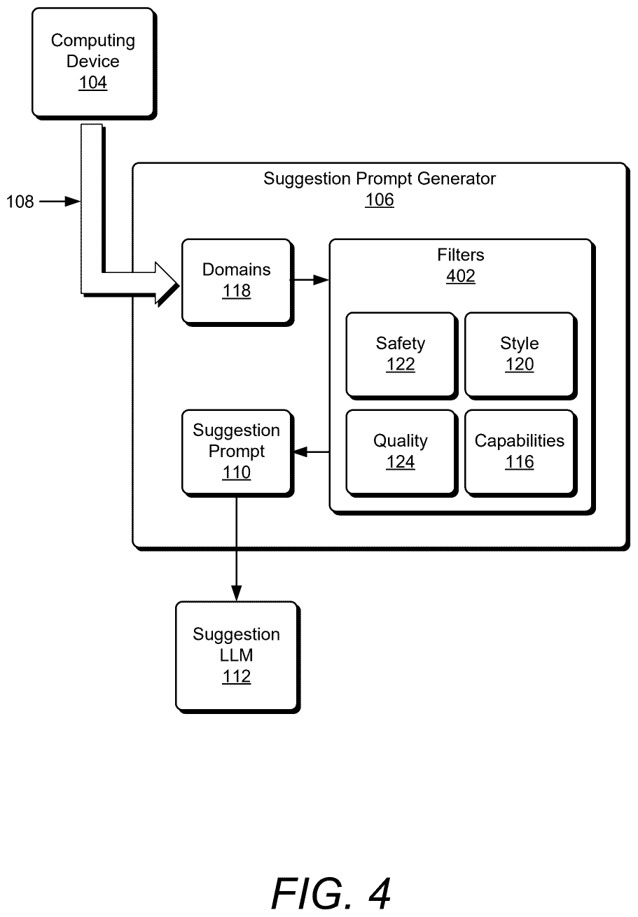

FIG. 4 illustrates an example block diagram 400 directed at implementing prompt generation for dynamic contextual suggestions. The suggestion prompt generator 106 receives the interaction data 108 from the computing device 104. The suggestion prompt generator 106 classifies the interaction data 108 into one or more specific domain from the domains 118. The classification of the interaction data 108 into the one or more specific domain may be based on a context of the interaction data 108. For example, the context can be based on parsing a conversation between a user of the computing device 104 and another user, a sensor in use by the user, an information presented to the user, etc.

In some examples, the suggestion prompt generator 106 parses the interaction data 108 through one or more filters 402. The one or more filters 402 may include the one or more parameters, filters, thresholds, etc. referenced in the discussion on FIG. 1 (the safety 122, the style 120, the quality 124, the capabilities 116, etc.). Examples of parsing of the interaction data 108 through the one or more filters 402 include changing or otherwise altering the one or more specific domain, appending the interaction data 108 with one or more qualifiers, and requesting to exclude a certain type of information, among other possible examples. After classifying the interaction data 108 in the one or more specific domain and applying the one or more filters 402, the suggestion prompt generator 106 generates the suggestion prompt 110. In aspects, the suggestion prompt 110 is configured to be an input for the suggestion LLM 112 and is generated based on one or more of the context, the one or more specific domain, and the one or more filters 402. In some examples, a first suggestion prompt is generated and filtered through the one or more filters 402 to generate the suggestion prompt 110. In aspects, the suggestion prompt 110 is sent to the suggestion LLM 112 as the input.

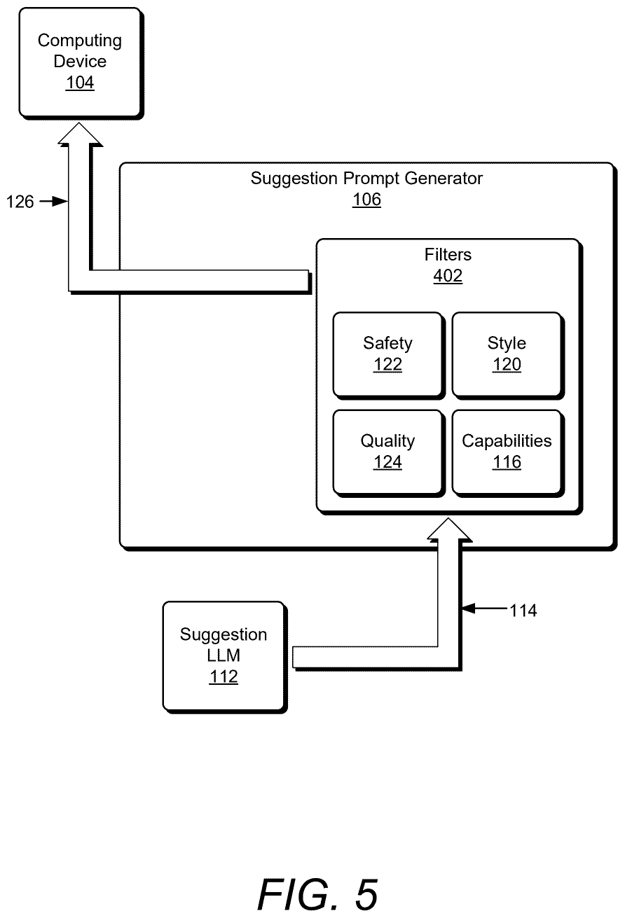

FIG. 5 illustrates an example block diagram 500 directed at implementing aspects of dynamic contextual suggestions. The suggestion prompt generator 106 receives the suggestion 114 from the suggestion LLM 112. The suggestion prompt generator 106, in some examples, filters the suggestion 114 through the one or more filters 402. For example, the suggestion prompt generator 106 determines that the one or more specific domain is a shopping domain and, further, that the suggestion 114 does not include pricing information. This may be determined by the quality 124 filter. The suggestion prompt generator 106 may modify the suggestion 114 to include the pricing information. In another example, the suggestion prompt generator 106 determines that the one or more specific domain is a travel domain and, further, that the suggestion 114 does not include an estimated time of arrival (ETA) for a determined destination. The suggestion prompt generator 106 may, in this example, leverage a mapping capability from the capabilities 116 to determine the ETA and include it with the suggestion 114.

The suggestion 114, in some cases modified as outlined, is used by the suggestion prompt generator 106 to generate the suggestion output 126. The suggestion output 126, in some examples, is the same as the suggestion 114. In other examples, the suggestion output 126 is a suggested action. In examples where the suggestion output 126 is a suggested action, the computing device 104 may receive an execution input based on the suggested action indicative of a user intent to execute the suggested action. The computing device 104 may, in response to receiving the execution input, perform the suggested action.

In some examples, the suggestion 114 is a plurality of suggestions. The suggestion prompt generator 106 may select a single suggestion from the plurality of suggestions. The suggestion prompt generator 106 may rank the plurality of suggestions based on one or more of the context, the interaction data 108 of FIG. 1, the domains 118 of FIG. 1, the one or more filters 402, or other relevant factors. In some examples, the suggestion output 126 includes more than one of the plurality of suggestions.

In some examples, the suggestion prompt generator 106 generates an evaluation value for the received suggestion 114, the evaluation value based on at least one of the suggestion 114, the context, the one or more specific domain, and the interaction data 108. The suggestion prompt generator 106 may compare the evaluation value with an evaluation threshold and, based on the comparison, generate another suggestion prompt (e.g., the suggestion prompt 110 of FIG. 1) configured to be another input to the suggestion LLM 112. For example, the quality 124 filter can determine that the suggestion 114 does not meet a quality threshold (e.g., the evaluation threshold) based on a content of the suggestion 114. In another example, the evaluation value may be an appropriateness score generated based at least in part on the safety 122 filter. For example, the suggestion 114 can contain information pertaining to a person the safety 122 lists as an inappropriate person. In such an example, the suggestion prompt generator 106 can determine that the appropriateness score does not meet an appropriateness threshold and can delete the suggestion 114 and/or generate a new suggestion prompt.

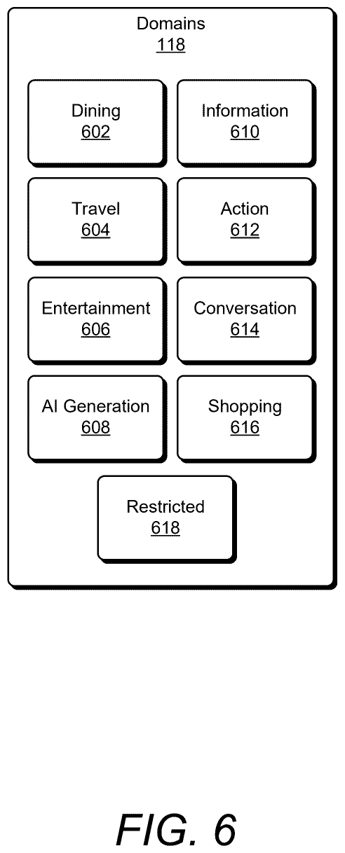

FIG. 6 illustrates examples 600 of the domains 118 of FIG. 1 used in prompt generation for dynamic contextual suggestions. The examples 600 include dining 602. For example, the dining 602 domain can include restaurants, food pricing, restaurant reviews, dining locations, one or more user preferences and/or rankings, seating availability and/or reservation information, or any other thing related to dining. The suggestion prompt generator 106 of FIG. 1 may use the dining 602 domain to classify the interaction data 108 of FIG. 1, to filter the interaction data 108, to generate the suggestion prompt 110 of FIG. 1, and/or to parse or modify the suggestion 114 of FIG. 1.

The examples 600 include travel 604. For example, the travel 604 domain can include mapping, location rankings and/or reviews, ticket booking, travel pricing, flights, cruises, rental cars, ride-share and/or taxi services, directions, or any other thing related to travel. The suggestion prompt generator 106 may use the travel 604 domain to classify the interaction data 108, to filter the interaction data 108, to generate the suggestion prompt 110, and/or to parse or modify the suggestion 114.

The examples 600 include entertainment 606. For example, the entertainment 606 domain can include movie information (showtimes, tickets, ratings, etc.), audio information, concert information and/or ticket booking, sporting events and sports related information, celebrity information, or any other thing related to entertainment. The suggestion prompt generator 106 may use the entertainment 606 domain to classify the interaction data 108, to filter the interaction data 108, to generate the suggestion prompt 110, and/or to parse or modify the suggestion 114.

The examples 600 include AI generation 608. For example, the AI generation 608 domain can include generative AI, image generation, text generation, video generation, or any other thing related to AI generation. The suggestion prompt generator 106 may use the AI generation 608 domain to classify the interaction data 108, to filter the interaction data 108, to generate the suggestion prompt 110, and/or to parse or modify the suggestion 114.

The examples 600 include information 610. For example, the information 610 domain can include internet-based information, information specific to the user or another user, information based on the computing device 104 of FIG. 1, or any other thing related to information. The suggestion prompt generator 106 may use the information 610 domain to classify the interaction data 108, to filter the interaction data 108, to generate the suggestion prompt 110, and/or to parse or modify the suggestion 114.

The examples 600 include action 612. For example, the action 612 domain can include home automation actions, security system actions, autonomous vehicle actions, device actions (remote devices, the computing device 104, etc.), or any other thing related to action. The suggestion prompt generator 106 may use the action 612 domain to classify the interaction data 108, to filter the interaction data 108, to generate the suggestion prompt 110, and/or to parse or modify the suggestion 114.

The examples 600 include conversation 614. For example, the conversation 614 domain can include text conversations, messaging applications, email, text generation, predictive text, or any other thing related to conversation. The suggestion prompt generator 106 may use the conversation 614 domain to classify the interaction data 108, to filter the interaction data 108, to generate the suggestion prompt 110, and/or to parse or modify the suggestion 114.

The examples 600 include shopping 616. For example, the shopping 616 domain can include shop rankings, online shopping, shopping applications, product reviews, comparisons, and/or availability, or any other thing related to shopping. The suggestion prompt generator 106 may use the shopping 616 domain to classify the interaction data 108, to filter the interaction data 108, to generate the suggestion prompt 110, and/or to parse or modify the suggestion 114.

The examples 600 include restricted 618. For example, the restricted 618 domain can include celebrities, political figures, hateful content, inappropriate content, or any other thing deemed restricted. The suggestion prompt generator 106 may use the restricted 618 domain to classify the interaction data 108, to filter the interaction data 108, to generate the suggestion prompt 110, and/or to parse or modify the suggestion 114. In some examples, the classification of the interaction data 108 in the restricted 618 domain causes the suggestion prompt generator 106 to not generate the suggestion prompt 110, delete the suggestion prompt 110, delete the suggestion 114, or to generate a new suggestion prompt.

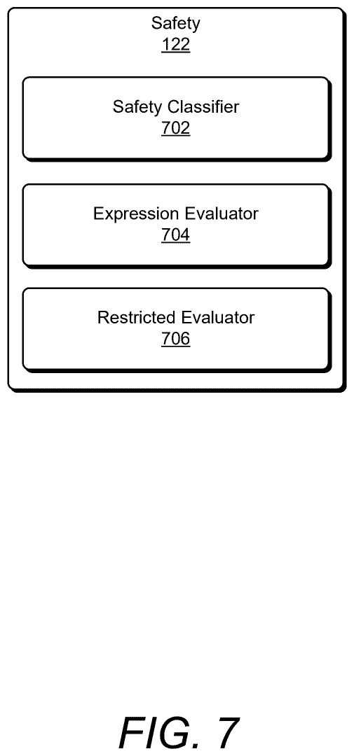

FIG. 7 illustrates examples 700 of the safety 122 of FIG. 1 for prompt generation for dynamic contextual suggestions. The safety 122 may include a safety classifier 702. For example, the safety classifier 702 can classify the interaction data 108 of FIG. 1 and/or the suggestion 114 of FIG. 1 as a safety violation. The safety violation classification from the safety 702 may cause the suggestion prompt generator 106 of FIG. 1 to modify or delete the suggestion prompt 110 and/or the suggestion 114. The safety classifier 702 may contain multiple filters, classifications, or other means of classifying the interaction data 108, the suggestion prompt 110, and/or the suggestion 114 as safety violations.

The safety 122 may also include an expression evaluator 704. The expression evaluator 704 may be used by the suggestion prompt generator 106 to parse the suggestion prompt 110 and/or the suggestion 114 to check for possible inappropriate or unallowed content. For example, consider the computing device 104 of FIG. 1 displaying the interaction data 108 in the form of political commentary being read by the user 102 of FIG. 1. The suggestion prompt generator 106 may read the interaction data 108 and create the suggestion prompt 110 in such a way that it asks the suggestion LLM 112 of FIG. 1 about the political commentary. The suggestion LLM 112 may respond with the suggestion 114 advising the user 102 to vote for a particular candidate. The expression evaluator 704 may modify (or cause the suggestion prompt generator 106 to modify) the suggestion 114 to recite information on what might motivate the recommendation rather than the suggestion 114 being a recommendation. The suggestion prompt 110 may similarly be altered by the expression evaluator 704.

The safety 122 may further include a restricted evaluator 706. Consider an example where the suggestion prompt generator 106 classifies the interaction data 108 in the entertainment 606 domain of FIG. 6. The suggestion prompt 110, in such an example, may query the suggestion LLM 112 for information on a particular person, who may be a political figure. In one example, the political figure is determined by the restricted evaluator 706 to be a forbidden person. The suggestion prompt generator 106 may not send the suggestion prompt 110 to the suggestion LLM. In another example where the suggestion prompt generator 106 has classified the interaction data 108 in the entertainment 606 domain, the suggestion prompt 110 again queries the suggestion LLM 112 for information on the particular person, but the particular person is not the forbidden person. However, for example, the suggestion 114 can contain a different person who the restricted evaluator 706 classifies as the forbidden person. In such an example, the suggestion 114 can be altered (by the restricted evaluator 706, by the suggestion prompt generator 106, etc.) or deleted.

### Large Language Models (LLMs)

Generally, LLMs are a class of artificial intelligence (AI). LLMs (e.g., the suggestion LLM 112 of FIG. 1, the suggestion prompt generator 106 of FIG. 1) are trained on enormous amounts of data to provide foundational capabilities, which can be used and reused, often through fine-tuning for particular applications and tasks. Other software applications, in contrast, are often built and trained on specific data for each use case. In this way, LLMs are considered a type of foundational model.

Some LLMs use a machine-learned (ML) computer model that can parse language and provide context-aware outputs, for example to mimic a human response. This mimic of a human response is typically to a prompt, for example from a user asking a question. The prompt “ask how to get to the train station in French,” for example, can be used as a prompt by which an LLM provides a translation service, namely a human response in the French language to the English language prompt. For the purposes of the present disclosure, the input prompt may be based on interaction data (e.g., the interaction data 108 of FIG. 1), for example the suggestion prompt 110 of FIG. 1.

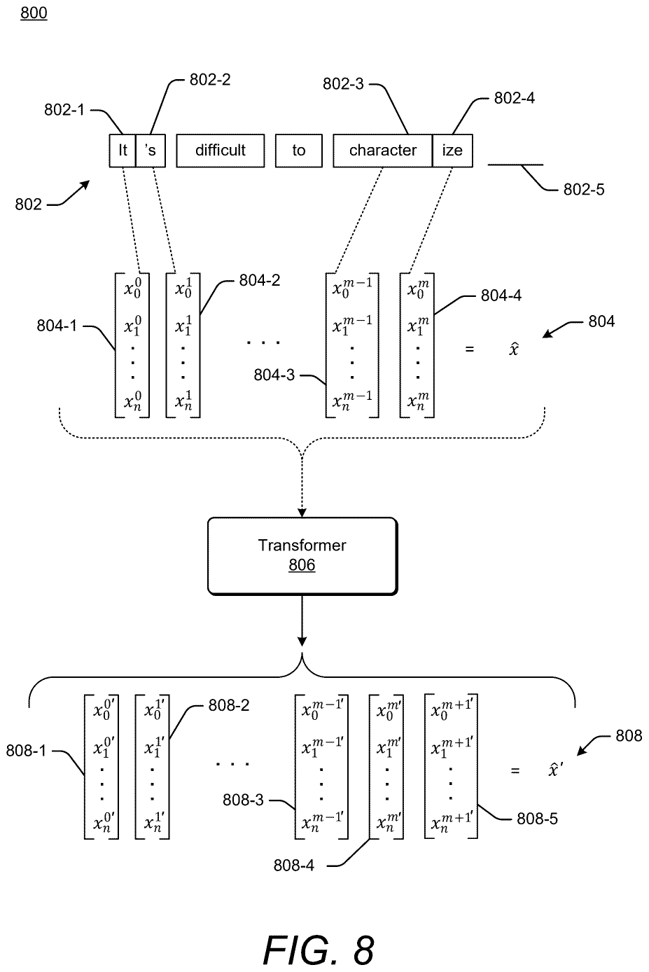

By way of example, consider FIG. 8, which illustrates a trainer 800 by which to train an LLM used for prompt generation for dynamic contextual suggestions (e.g., the suggestion prompt generator 106 of FIG. 1, the suggestion LLM 112 of FIG. 1). The trainer 800 receives training data as training inputs, for example an input 802. This training data may be of many different types, for example output data (e.g., the interaction data 108 of FIG. 1) related to an electronic device (e.g., the computing device 104 of FIG. 1). In the example illustrated by FIG. 8, the training input 802 is a phrase, though it may instead be a word, a long text passage (e.g., a book, article, or web-page), or any other data containing comprehensible text. In some examples, the text is from a screen or image capture. In a process called “tokenization,” the trainer 800 breaks the training input 802 into tokens, marked as tokens 802-1, 802-2, 802-3, and 802-4. Here the training input 802 has a missing next word, marked as a blank 802-5. The goal of the trainer 800 is to predict the blank 802-5.

The trainer 800 encodes the tokens (802-1, 802-2, etc.) into an input tensor \hat{x} 804 through a mapping procedure. For instance, the token “It” 802-1 is mapped to a first component 804-1 of the input tensor \hat{x} 804, the token “'s” is mapped to a second component 804-2 of the input tensor \hat{x} 804, the token “character” is mapped to a third component 804-3 of the input tensor î 804, and the token “ize” is mapped to a fourth component 804-4 of the input tensor \hat{x} 804. Though the tokens “It” 804-1 and “'s” 804-2 are shown as two portions of the word “It's,” other mapping schemes exist, for example mapping based on discrete words or phonemes. In some instances, an ML model or an ML component of the trainer 800 performs the tokenization and/or mapping of the training input 802 into the input tensor \hat{x} 804 (e.g., a feature-extracting convolutional neural network (CNN)). The mapping of the tokenized training input 802 into the input tensor î 804 may involve a lookup table, which maps each possible token (e.g., 802-1, 802-2, etc.) to a known tensor object in a language space of the training data.

A transformer 806 takes the input tensor \hat{x} 804 as an input, with the goal of predicting the blank 802-5 by transforming the input tensor \hat{x} 804 into a transformed tensor \hat{x}′ 808. The transformation process is mathematically represented as follows:

$$T \hat{x} = {\hat{x}}^{′} \qquad Eq . 1$$

T in Eq. 1 represents the transformer 806. The transformed tensor \hat{x}′ 808 includes components 808-1, 808-2, 808-3, 808-4, and 808-5. The component 808-1 is a transformation of the component 804-1 by the transformer 806 (similar for component pairs 808-2/804-2, 808-3/804-3, and 808-4/804-4). The component 808-5 corresponds to the blank 802-5, and thus the component 808-5 is a prediction for the blank 804-5. The final transformed tensor \hat{x}′ 808 component 808-5 is derived as part of the transformation process in addition to the contextualization of the components 804-1 through 804-4.

Inputs, e.g., the input tensor \hat{x} 804 and/or the training input 802, generally include multiple tokens. For instance, the training input 802 includes the tokens 802-1 through 802-4. The trainer 800 converts a single training input (e.g., the training input 802) into multiple training inputs. For example, by removing the token 802-4, the blank 802-5 “shifts left” as the training input 802 calls for the trainer 800 to predict the token 802-4, thus creating a new training input from the original training input 802. As the value for the token 802-4 is known in this example, the new input is a labeled input, which allows it to be used by a supervised ML training algorithm (it should be noted that such an input is also able to be used by an unsupervised ML training algorithm). In this way, a single text containing multiple tokens (e.g., a book, a research paper, etc.) is used as multiple training inputs for the trainer 800.

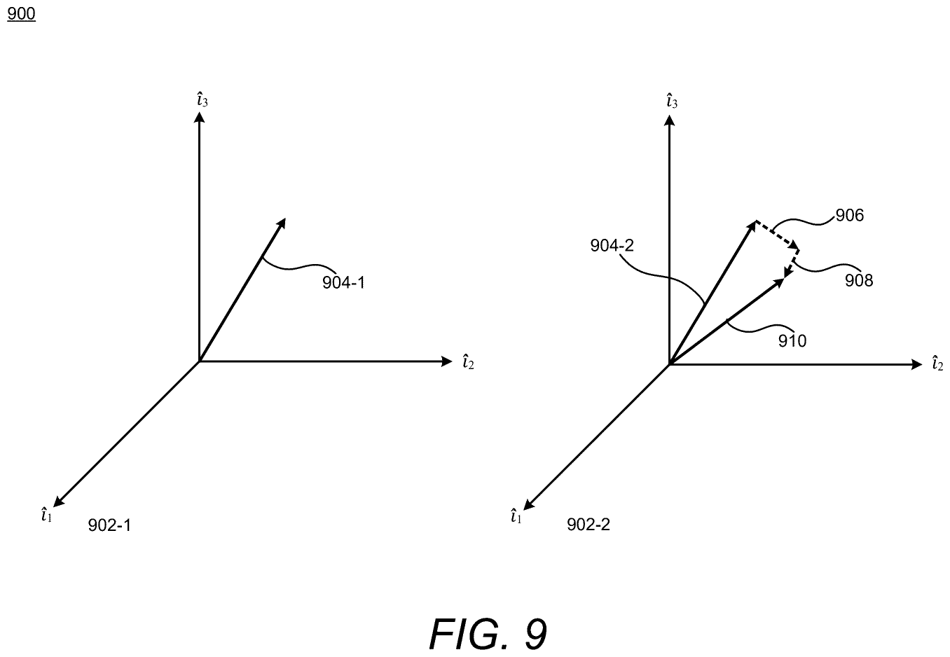

FIG. 9 illustrates an example transformation 900 in a language space 902-1 of an input tensor component 904-1 (e.g., the component 804-1 of the input tensor \hat{x} 804 of FIG. 8). The language space 902-1 is a multi-dimensional mathematical space, which includes specific language components codified as tensors within the multi-dimensional mathematical space. The term “tensor” is a mathematical object of any dimensionality, including scalar, vector, and matrix quantities. The language space 902-1 is therefore a mathematical vocabulary, and mapped tokens (e.g., token 802-1 of FIG. 8) are tokens that have been translated into the mathematical vocabulary. For case of illustration, the language space 902-1 is shown in FIG. 9 as a three-dimensional space with orthogonal basis vectors \hat{l}₁, \hat{l}₂, and \hat{l}₃. However, this should not be seen as limiting. In general, the language space 902-1 has the dimensionality of the mapped tokens from an input tensor. For example, the input tensor \hat{x} 804 of FIG. 8, whose tensor components 804-1 through 804-4 each contain n members, corresponds to an n-dimensional language space.

The input tensor component 904-1 is plotted in the language space 902-1, shown in FIG. 9 as a vector in three-dimensional space. In some examples, the plotting is the product of a lookup table, a CNN feature mapping, or any other mapping from the token into the language space 902-1. The input tensor component 904-1 is transformed by the transformation 900. Consider a language space 902-2, identical to the language space 902-1, and an input tensor component 904-2, identical to the input tensor component 904-1. The transformation 900 is based on transformation operators 906 and 908 and performed by a transformer. The transformation operators 906 and 908 are illustrated as vector addition operators, resulting in a remapped tensor 910.

As an illustration of this transformation, let the input tensor component 904-2 represent a mapped (e.g., translated into the mathematical vocabulary of the language space 902-2) token of “rodent” and let the transformation operators 906 and 908 be generated by contextualizing mapped tokens “large” and “eared” from an input prompt, which includes the phrase “large-eared rodent.” Contextualizing is defined as characterizing the correlations between “rodent,” “large,” and “eared” from the input prompt (e.g., the input 802 of FIG. 8) in a way that corresponds with how a speaker of the input prompt's language would understand the word “rodent” as it appears in the input prompt along with “large” and “eared.” In this illustration, the transformed tensor 910 maps to an area of the language space 902-2 containing the word “chinchilla.”

Though the transformation of the input tensor component 904-2 to the transformed tensor 910 has been shown as two transformations using the transformation operators 906 and 908, this should not be seen as limiting. Any number of transformation operations may be employed, including more than two or a single transformation operation. Transformation operators (e.g., the transformation operator 906) may also take forms other than vector/tensor addition, for example multiplication (e.g., scaling, matrix multiplication, dot product, cross product, tensor product, etc.), normalization, orthogonalization, or any combination of these or other transformation operations known to a person of ordinary skill in the art. Thus, the transformation operators 906 and 908 of FIG. 9 are meant to be illustrative, not limiting.

Sophisticated LLMs may have a very large number of trained parameters, with modern LLMs boasting hundreds of billions of parameters in their employed models. Because of this, it is often advantageous not to train an LLM from scratch but rather to fine-tune an already-trained model. To give a human analogy, this is much like teaching a person who already knows a language how to write in the American Psychological Association (“APA”) style. It takes an entire upbringing for the person to master the language, but a single university course suffices to learn the APA writing style.

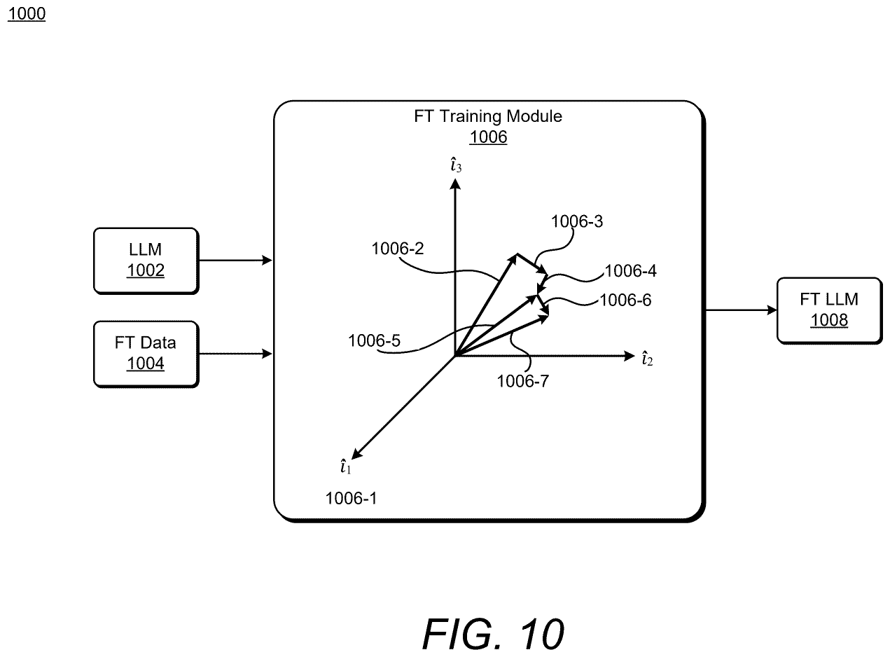

By way of example, consider FIG. 10, which illustrates a fine-tuning (FT) trainer 1000. The FT trainer 1000 takes an LLM 1002 (e.g., an LLM previously trained by the trainer 800 of FIG. 8) and FT data 1004 as training inputs. For example, the FT data 1004 may be the interaction data 108 of FIG. 1. The FT trainer 1000 includes an FT training module 1006 and a final output in the form of an FT LLM 1008. In an example, the FT trainer 1000 can be used to fine-tune the suggestion LLM 112 of FIG. 1 into the suggestion prompt generator 106 of FIG. 1.

The FT training module 1006 includes a language space 1006-1. Though the language space 1006-1 has here been illustrated as a three-dimensional space with orthogonal basis axes \hat{l}₁, \hat{l}₂, and \hat{l}₃, this should not be seen as limiting. In general, the language space 1006-1 may have the dimensionality of its input data, for example an input tensor 1006-2. The language space 1006-1, in some examples, may be of a lower dimension than a language space used to train the LLM 1002 (e.g., the language space 902-1 of FIG. 9). The input tensor 1006-2 (e.g., the component 804-2 of FIG. 8) is mapped into the language space 1006-1 and transformed by transformation operators 1006-3 and 1006-4. The transformation performed by the transformation operators 1006-3 and 1006-4 is by way of the LLM 1002, giving a resultant transformed tensor 1006-5 (e.g., the transformation 900 of FIG. 9). In some examples (not pictured), the transformation process may include a change of basis into another language space or a mapping into a smaller language space.

The FT training module 1006 includes an additional transformation operator 1006-6, resulting in a final tensor 1006-7. This may be represented mathematically as follows:

$$F ( T \hat{x} ) = {\hat{x}}^{′} + δ x \qquad Eq . 2$$

T, as in Eq. 1, is the transformation performed by the LLM 1002 (e.g., an LLM trained by the trainer 800 of FIG. 8), F is the additional transformation operator 1006-6, \hat{x}′ is the transformed tensor 1006-5 (e.g., the transformed tensor 910 of FIG. 9), and δx is a perturbation component. The perturbation component δx is shown in the language space 1006-1 as the additional transformation operator 1006-6, giving the final tensor 1006-7. The perturbation component δx is based on the FT data 1004. The final tensor 1006-7 is the mapped representation of \hat{x}′+δx. This gives the FT LLM 1008 all of the capabilities of the LLM 1002 with the additional context of the FT data 1004.

Consider, as before, an example of the input tensor 1006-2 representing a mapping of a token “rodent” into the language space 1006-1, the transformation operator 1006-3 representing a mapping of a token “large” into the language space 1006-1, and the transformation operator 1006-4 representing a mapping of a token “eared” into the language space 1006-1. The transformed tensor 1006-5 represents a region of the language space 1006-1 containing “chinchilla.”

By way of example, suppose a veterinarian office wishes to fine-tune (FT) train the LLM 1002 to associate types of medications with animal types. Training the entire LLM 1002 is logistically prohibitive, and a different LLM containing the correlation between the types of medication and the animal types may be unavailable. Instead, the veterinarian office employs the FT trainer 1000, where the FT data 1004 includes the correlations between the types of medication and the animal types. The additional transformation operator 1006-6 associates a chinchilla with a specific type of medication. Thus, the final tensor 1006-7 contains the type of medication corresponding with, for example, rodents, which is not found in the LLM 1002.

While the FT training module 1006 has been shown as performing the additional transformation operator 1006-6 as a single operation, this need not be the case. The additional transformation operation 1006-6 may include several operations, a change in dimensionality, or any other of a number of transformations known to a person of ordinary skill in the art. Further, the FT training module 1006 may include other components not pictured, for example multi-layer perceptron (MLP) or CNN components, additional feature mapping, etc. The illustration of a single operation for the additional transformation operator 1006-6 is shown for brevity and to aid in understanding, not to express a limitation on the functionality of the FT training module 1006.

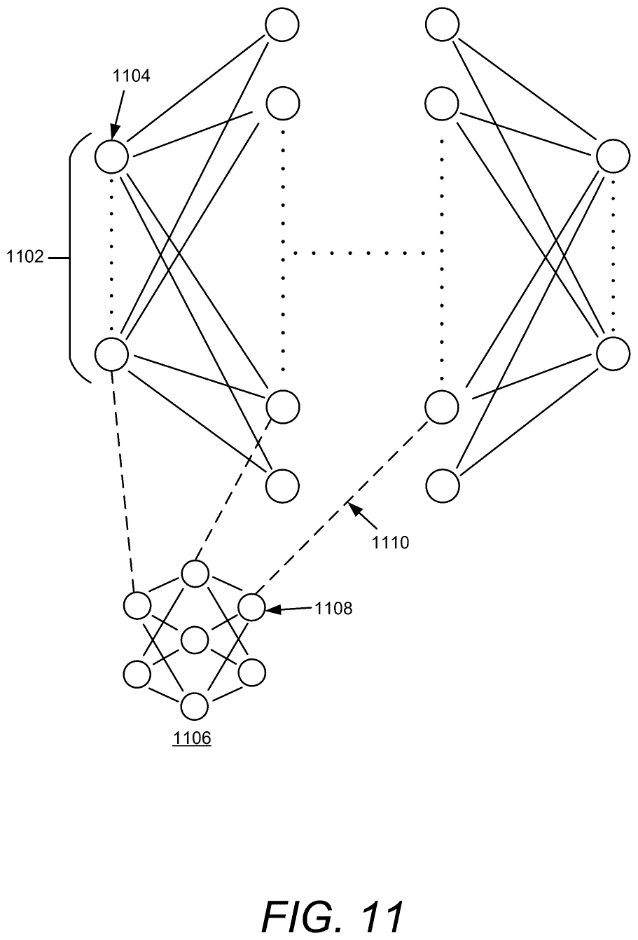

FIG. 11 illustrates an example low-rank adaptation (LorA) training 1100 for an LLM 1102 (e.g., the suggestion LLM 112 of FIG. 1). The LorA training 1100 can be used to fine-tune the LLM 1102. One advantage of the LorA training 1100 is that not all parameters 1104 of the LLM 1102 are tuned, resulting in a much less computationally costly training than fine-tuning all parameters 1104 of the existing LLM 1102. In some examples, the suggestion prompt generator 106 of FIG. 1 is a LorA-trained version of the suggestion LLM 112. In some examples, the suggestion prompt generator 106 is a plurality of LorA-trained versions of the suggestion LLM 112, the suggestion LLM 112 is a plurality of LorA-trained versions of a general LLM, or both.

The LorA training 1100 employs a training ML model 1106. The training ML model 1106 has LorA weights 1108, which modify only some of the parameters 1104 of the LLM 1102 (indicated by the dashed lines 1110). The LLM 1102 can, in some examples, be represented as a matrix of pre-trained weights (for example by the trainer 800 of FIG. 8) W_{m,n}, where m and n represent the dimensionality of the matrix W_{m,n}. In a full fine-tuning training (e.g., using the FT trainer 1000 of FIG. 10), the matrix W_{m,n} is modified by a modification matrix Δw_{m,n}, which is a matrix also of dimension m×n. In examples where the LLM 1102 is large (e.g., 200B parameters), the modification matrix ΔW_{m,n} is also large and can thus be intensive in both computational training resources and in storage resources. In examples where multiple FT trained LLMs are sought, the problem is compounded.

The LorA training 1100 can, in some examples, greatly reduce the cost of the modification matrix ΔW_{m,n}. Consider the following equation:

$$Δ {W}_{m , n} = \vert {x}_{m , r} 〉 〈 {y}_{r , n} \vert \qquad Eq . 3$$

In Eq. 3, |x_{m,r} [symbol] is a matrix of dimension m×r and [symbol] y_{r,n}| is a matrix of dimension r×n. In the small limit, r=1 making |x_{m,r} [symbol] and [symbol] y_{r,n}| contravariant and covariant vectors of rank 1, respectively. This can, in aspects, greatly reduce the dimensionality and thus the computational cost of fine-tuning compared with ΔW_{m,n} being stored and used as a dimensionality m×n matrix. For example, consider the LLM 1102 represented by W_{m,n} with m=n=445,000, giving 198,025,000,000 total parameters. Using the LorA training 1100, at the low end of r=1, ΔW_{m,n} may be represented by two vectors, |x_{m,r} [symbol] and [symbol] y_{r,n}|, which have a dimension of only 445,000, resulting in:

$$\frac{[ Δ {W}_{m , n} ]}{[ {W}_{m , n} ]} ≅ 2 \text{.2472} \cdot {10}^{- 6} \qquad Eq . 4$$

Eq. 4 shows an example of the modification matrix ΔW_{m,n} size being 0.00022472% the size of W_{m,n}. The result is, in some examples, an ability to FT train the LLM 1102 with a relatively small set of parameters (e.g., the LorA weights 1108). In this way, FT LLMs based on the LLM 1102 may be created. For example, if the LLM 1102 is the suggestion LLM 112 and the suggestion prompt generator 106 is at least in part a product of the LorA training 1100, a plurality of specialized LLMs based on the suggestion LLM 112 can be easily stored on a user device (e.g., the computing device 104 of FIG. 1).

### Example Methods

The method 1200 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to any of the preceding figures or processes as detailed in other figures, reference to which is made for example only. The techniques are not limited to performance by one entity or multiple entities operating on one device.

Generally, any of the components, modules, methods, and operations described herein can be implemented using software, firmware, hardware (e.g., fixed logic circuitry), manual processing, or any combination thereof. Some operations of the example methods may be described in the general context of computer program products, for example executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, for example, and without limitation, field-programmable gate arrays (FPGAs), application-specific integrated circuits (ASICs), application-specific standard products (ASSPs), system-on-a-chip systems (SoCs), complex programmable logic devices (CPLDs), and the like.

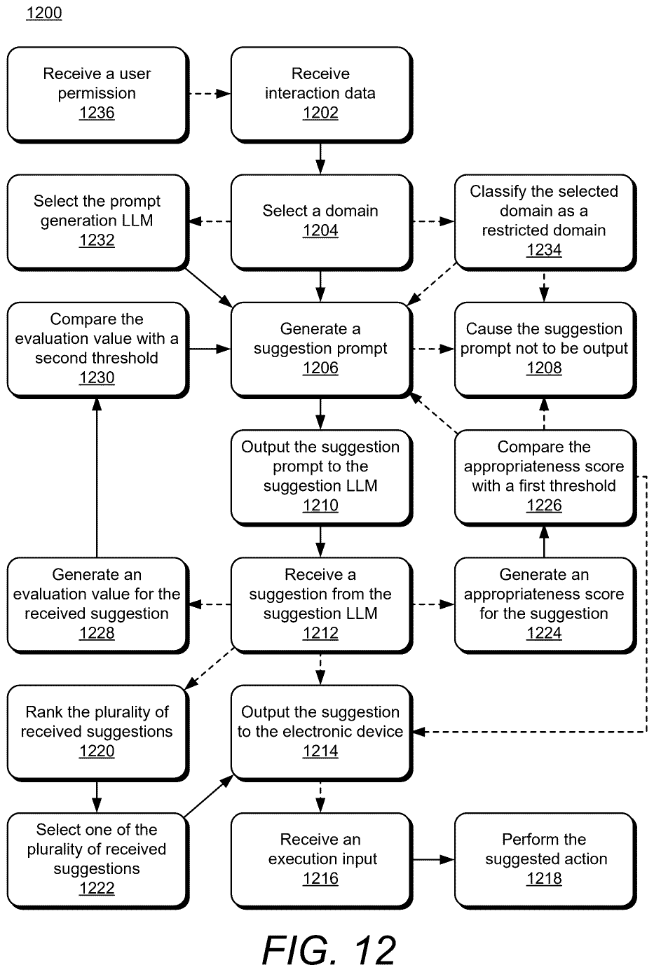

FIG. 12 illustrates an example method 1200 for prompt generation for dynamic contextual suggestions in accordance with one or more implementations. At 1202, interaction data (e.g., the interaction data 108 of FIG. 1) is received. In aspects, the interaction data is received by a suggestion prompt generator (e.g., the suggestion prompt generator 106 of FIG. 1). The interaction data is configured to be output to an electronic device (e.g., the computing device 104 of FIG. 1). In an example, the interaction data is display data configured to be output to a display element (e.g., the display element 306 of FIG. 3). According to some examples, the interaction data is received via a screen-capture or screen-reader mechanism. In some examples, the receipt of the interaction data is performed automatically. In other examples, the receipt of the interaction data is responsive to a user input. In aspects, the interaction data includes a context.

At 1204, a domain (e.g., one of the domains 118 of FIG. 1) is selected. The selection of the domain is based on at least one of the interaction data and the context. In some examples, the selection of the domain is performed by the suggestion prompt generator. According to some examples, the domain is one of a plurality of available domains. The plurality of domains may include one or more of dining, travel, entertainment, information, action, conversation, shopping, generation, and restricted.

At 1206, a suggestion prompt (e.g., the suggestion prompt 110 of FIG. 1) is generated. The generation of the suggestion prompt, in aspects, is based on at least one of the interaction data, the context, and the domain. In aspects, the suggestion prompt is configured to be input into a suggestion LLM (e.g., the suggestion LLM 112 of FIG. 1). In some examples, the suggestion prompt generation is further based on a capability (e.g., one of the capabilities 116 of FIG. 1) of the electronic device. The capabilities may include one or more of an application able to be instantiated on the electronic device and one or more sensors (e.g., the sensors 308 of FIG. 3) of the electronic device. The application able to be instantiated on the electronic device may be a map application, a navigation application, an online shopping application, an entertainment application, a news application, a messaging application, or a generative AI application. In some examples, the capability may be a function of an AI assistant.

At 1208, the suggestion prompt is caused to not be output. The causing of the suggestion prompt to not be output may be due to a safety filter (e.g., the safety 122 of FIG. 1). For example, the safety filter can determine that the suggestion prompt contains unallowed material.

At 1210, the suggestion prompt is output to the suggestion LLM. In some examples, the outputting of the suggestion prompt to the suggestion LLM is performed on the electronic device. In other examples, the outputting of the suggestion prompt to the suggestion LLM is performed using a remote communication module of the electronic device (e.g., the wireless communication module 310 of FIG. 3).

At 1212, a suggestion (e.g., the suggestion 114 of FIG. 1) is received from the suggestion LLM. In some examples, the suggestion is received by the suggestion prompt generator. In other examples, the suggestion is received by the electronic device. The received suggestion may be a plurality of suggestions. The received suggestion may be parsed by the suggestion prompt generator, for example based on the capabilities.

At 1214, the suggestion is output to the electronic device. In some examples, the output of the suggestion to the electronic device includes a style (e.g., one of the styles 120 of FIG. 1) of output. The style of output may be one or more of a conversational style, a formal style, a humorous style, or a custom style. In some examples, the style is based at least in part on the context.

At 1216, an execution input is received. In aspects, the execution input is based on the suggestion output to the electronic device. The execution input, in aspects, is indicative of a user intent to execute a suggested action based on the suggestion. For example, the suggestion may be a suggestion to make a reservation at a restaurant with a “Yes” or “No” selection for the user. In this example, the user can select “Yes” to direct the electronic device to make the reservation.

At 1218, the suggested action is performed. For example, the suggested action can be a command to control or otherwise manipulate an autonomous vehicle, a security element of a security system, control of a home automation component, control of a functionality of the electronic device, or any other type of action. In an example where the suggestion is a suggestion to share a user location, the user can provide the execution input to share the location. The electronic device may then share the user location, as suggested.

At 1220, proceeding from the example where the suggestion is a plurality of suggestions, the plurality of received suggestions is ranked. In aspects, the ranking is based at least in part on one or more of the context, the selected domain, and the interaction data. The ranking may include comparing each of the plurality of received suggestions to a ranking threshold value.

At 1222, one of the plurality of received suggestions is selected based at least in part on the ranking. For example, the ranking can rank a first suggestion of the plurality of received suggestions in a number one spot, a second suggestion of the received suggestions in a number two spot, etc. The first suggestion may be selected based on it holding the number one rank. In an example where two or more suggestions share a top rank, other criteria can be used to determine which of the two or more suggestions is selected. The method then proceeds to 1214.

At 1224 and proceeding from 1212, an appropriateness score is generated for the suggestion. The appropriateness score may be based on one or more filters (e.g., the filters 402 of FIG. 4). For example, the suggestion can contain information pertaining to a political figure that one or more of the filters 402 have listed as a forbidden person. This information may cause the appropriateness score to be affected (e.g., to increase, decrease, rise above a threshold value).

At 1226, the appropriateness score is compared with a first threshold. Based on the comparison, the suggestion may be output to the electronic device (as in 1214), caused to not be output (as in 1208), or a request for a new suggestion prompt may be made (as in 1206). In some examples, a parameter influencing the appropriateness score can be such that the suggestion is automatically deemed to exceed the first threshold, thereby causing the suggestion to not be output and the request for a new suggestion prompt to be made. In another example, certain problematic keywords can be detected in the suggestion, each with an associated appropriateness score. In this example, consider the sum of the appropriateness scores not adding up to the first threshold, causing the suggestion to be output to the electronic device.

At 1228, an evaluation value for the received suggestion is generated. According to some examples, the evaluation value is generated by the suggestion prompt generator. In aspects, the evaluation value is based on at least one of the received suggestion, the context, the domain, and the interaction data. The evaluation value may further be based on evaluation criteria, for example information found in the one or more filters.

At 1230, the evaluation value is compared with a second threshold. In some examples, responsive to the comparison of the evaluation value with the second threshold, a second suggestion prompt is requested (as in 1206). In some examples, the second suggestion prompt is configured to modify the suggestion for a style, appropriateness, content, or other facet. In some examples, based on the comparison of the evaluation value with the threshold, the suggestion is output to the electronic device (as in 1214; not shown for clarity of display purposes).

At 1232 and proceeding from 1204, a prompt generation LLM is suggested. In some examples, the prompt generation LLM is included in the suggestion prompt generator. The prompt generation LLM may be based on the suggestion LLM, for example by fine-tuning the suggestion LLM with a FT trainer (e.g., the FT trainer 1000 of FIG. 10). The FT trainer may use a LorA training (e.g., the LorA training 1100 of FIG. 11). In some examples, the prompt generation LLM is stored in a memory (e.g., the computer-readable medium 304 of FIG. 3). In aspects, the prompt generation LLM is one of a plurality of available prompt generation LLMs and the selection of the prompt generation LLM is based at least in part on one or more of the context, the domain, and the interaction data. The method proceeds to 1206.

At 1234, the selected domain is classified as a restricted domain (e.g., the restricted 618 domain of FIG. 6). The classifying as the restricted domain may be based on at least one of the context or the interaction data. Based on the classification of the domain as a restricted domain, the method proceeds to either 1208 or 1206.

At 1236, a user permission is received. For example, a user (e.g., the user 102 of FIG. 1) may grant permission for the suggestion prompt generator to generate suggestions, which requires access to the interaction data. In some examples, the user permission is persistent. In other examples, the user permission is an acute permission (e.g., a one-time permission). Based on the receipt of the user permission, the method proceeds to 1202.

Throughout this disclosure, examples are described where a computing system (e.g., the computing device 104) may analyze information (the interaction data 108, screen capture data, audio output data, etc.) associated with a user (e.g., the user 102), for example, the interaction data 108 can be text from a messaging application (e.g., from the instantiated conversation application 202). Further to the descriptions above, the user may be provided with controls allowing the user to make an election as to both if and when systems, programs, and/or features described herein may enable collection of information (e.g., information about a user's social network, social actions, social activities, profession, a user's preferences, a user's current location), and if the user is sent content or communications from a server. The computing system can be configured to only use the information after the computing system receives explicit permission from the user of the computing system to use the data. For example, in situations where an application of the computing system contains private messaging data used as the information, the user may be provided with an opportunity to provide input to control whether programs or features of the computing system can collect and make use of the information. Further, individual users may have constant control over what programs can or cannot do with the information. In addition, information collected may be pre-treated in one or more ways before it is transferred, stored, or otherwise used, so that personally-identifiable information is removed. For example, the private messaging data can have personally identifying facets, names, and/or faces removed. Thus, the user may have control over whether information is collected about the user and the user's device, and how such information, if collected, may be used by the computing system and/or a remote computing system

### Additional Examples

Various examples are described herein, including a first example method (example 1) that includes receiving, by one or more processors, interaction data, the interaction data comprising a context. The method further includes selecting, by the one or more processors and based on at least one of the interaction data and the context, a domain from among a plurality of available domains and generating, by the one or more processors and based on the domain, a suggestion prompt configured to be an input to a suggestion large language model (LLM).

Example 2: The method of example 1, further including outputting, by the one or more processors, the suggestion prompt to the suggestion LLM and receiving, by the one or more processors and from the suggestion LLM, a suggestion configured to be output to an electronic device.

Example 3: The method of example 2, wherein the received suggestion includes a plurality of received suggestions.

Example 4: The method of claim 3, further including ranking, by the one or more processors, the plurality of received suggestions, the ranking based at least in part on one or more of the context, the domain, and the interaction data.

Example 5: The method of example 4, further including selecting, by the one or more processors, one of the plurality of received suggestions based on the ranking.

Example 6: The method of example 2, further including generating, by the one or more processors, an evaluation value for the received suggestion, the evaluation value based on at least one of the received suggestion, the context, the domain, and the interaction data. The method further includes comparing, by the one or more processors, the evaluation value with an evaluation threshold and, based on the comparison, generating another suggestion prompt configured to be another input to the suggestion LLM.

Example 7: The method of example 2, further including generating, by the one or more processors, an appropriateness score for the suggestion and comparing the appropriateness score with an appropriateness threshold. The method further includes, based on the comparing of the appropriateness score with the appropriateness threshold, outputting, by the one or more processors, the suggestion to the electronic device or deleting the suggestion.

Example 8: The method of example 2, further including outputting the suggestion to the electronic device, the outputting of the suggestion comprising outputting one or more of a display output, an audio output, or a tactile output and the interaction data is based on one or more of a display input, a voice input, or a touch input.

Example 9: The method of example 8, wherein the output of the suggestion to the display element includes a style of output.

Example 10: The method of example 9, wherein the style of output is one or more of a conversational style, a formal style, a humorous style, or a custom style.

Example 11: The method of example 9, wherein the style of output is based at least in part on the context.

Example 12: The method of example 8, further including receiving, by the one or more processors, an execution input based on the suggestion output to the electronic device, the execution input indicative of a user intent to execute a suggested action based on the suggestion, and performing, by the one or more processors, the suggested action.

Example 13: The method of example 1, wherein the interaction data includes a screen capture of a current output to a display element.

Example 14: The method of example 1, wherein the receipt of the interaction data is performed automatically.

Example 15: The method of example 1, wherein the receipt of the interaction data is responsive to a user input.

Example 16: The method of example 1, wherein the generation of the suggestion prompt is performed by a prompt generation LLM.

Example 17: The method of example 16, wherein the prompt generation LLM is based on the suggestion LLM.

Example 18: The method of example 17, wherein the prompt generation LLM is a low-rank adaptation (LoRA) of the suggestion LLM.

Example 19: The method of example 16, wherein the prompt generation LLM is one of a plurality of available prompt generation LLMs, the method further including selecting the prompt generation LLM from among the plurality of available prompt generation LLMs, the selection of the prompt generation LLM based at least in part on one or more of the interaction data, the context, or the domain.

Example 20: The method of example 16, wherein the prompt generation LLM is stored on a memory of an electronic device, the electronic device including the one or more processors.

Example 21: The method of example 1, wherein the plurality of available domains include one or more of dining, travel, entertainment, information, action, conversation, shopping, generation, and restricted.

Example 22: The method of example 1, wherein the generation of the suggestion prompt is further based on a capability of an electronic device, the electronic device including the one or more processors.

Example 23: The method of example 22, wherein the capability includes an application able to be instantiated on the electronic device.

Example 24: The method of example 23, wherein the application is one of a map application, a navigation application, an online shopping application, an entertainment application, a news application, a messaging application, or a generative artificial intelligence (AI) application.

Example 25: The method of example 22, wherein the capability comprises one or more sensors of the electronic device.

Example 26: The method of example 1, further comprising receiving a user permission to access the interaction data, wherein the receipt of the interaction data is responsive to the receipt of the user permission.

Example 27: The method of example 1, further including classifying, by the one or more processors, the selected domain as a restricted domain and, responsive to the classification of the domain as a restricted domain, causing the generated suggestion prompt to not be output to the suggestion LLM.

Example 28: The method of example 2, further including searching, by the one or more processors, the suggestion for restricted content and, based on the restricted content, either modifying and outputting, by the one or more processors, the suggestion to the electronic device; or deleting, by the one or more processors, the suggestion.

Example 29: An electronic device comprising one or more processors and a memory storing instructions that, when accessed by the one or more processors, cause the one or more processors to execute any one of the methods of examples 1-28.

Example 30: A non-transitory, computer-readable medium storing instructions that, when accessed by one or more processors, cause the one or more processors to execute any one of the methods of examples 1-28.

Example 31: A computer program product comprising instructions that, when accessed by one or more processors, cause the one or more processors to execute any one of the methods of examples 1-28.

### CONCLUSION

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Although concepts of prompt generation for dynamic contextual suggestions have been described in language specific to techniques and/or systems, it is to be understood that the subject of the appended claims is not necessarily limited to the specific techniques or methods described. Rather, the specific techniques and methods are disclosed as example implementations for prompt generation for dynamic contextual suggestions.

What is claimed is:

1. An electronic device comprising:
one or more processors; and
a memory storing instructions that, when accessed by the one or more processors, cause the one or more processors to:
receive interaction data, the interaction data comprising a context;
select, based on at least one of the interaction data and the context, a domain from among a plurality of available domains; and
generate, based on the domain, a suggestion prompt configured to be an input to a suggestion large language model (LLM).

2. The electronic device of claim 1, wherein the instructions further cause the one or more processors to:
output the suggestion prompt to the suggestion LLM; and
receive, from the suggestion LLM, a suggestion configured to be output to the electronic device.

3. The electronic device of claim 2, wherein the instructions further cause the one or more processors to:
search the suggestion for restricted content; and
based on the restricted content, either:
modify and output the suggestion to the electronic device; or
delete the suggestion.

4. The electronic device of claim 2, wherein:
the instructions further cause the one or more processors to output the suggestion to the electronic device, the output of the suggestion comprising one or more of a display output, an audio output, or a tactile output; and
the interaction data is based on one or more of a display input, a voice input, or a touch input.

5. The electronic device of claim 2, wherein the suggestion comprises a suggested action and the instructions further cause the one or more processors to:
receive an execution input based on the suggestion output to the display element, the execution input indicative of a user intent to execute a suggested action based on the suggestion; and
perform the suggested action.

6. The electronic device of claim 1, wherein:
the electronic device further comprises a display element; and
the interaction data comprises a screen capture of a current output to the display element.

7. The electronic device of claim 1, wherein the generation of the suggestion prompt is performed by a prompt generation LLM.

8. The electronic device of claim 7, wherein the prompt generation LLM is based on the suggestion LLM.

9. The electronic device of claim 7, wherein the prompt generation LLM is one of a plurality of available prompt generation LLMs and the instructions further cause the one or more processors to select the prompt generation LLM from among the plurality of available prompt generation LLMs, the selection of the prompt generation LLM based at least in part on one or more of the interaction data, the context, or the domain.

10. The electronic device of claim 1, wherein the plurality of available domains comprise one or more of dining, travel, entertainment, information, action, conversation, shopping, artificial intelligence (AI) generation, and restricted.

11. The electronic device of claim 1, wherein the generation of the suggestion prompt is further based on a capability of the electronic device.

12. The electronic device of claim 11, wherein the capability comprises an application able to be instantiated on the electronic device.

13. A method comprising:
receiving, by one or more processors, interaction data, the interaction data comprising a context;
selecting, by the one or more processors and based on at least one of the interaction data and the context, a domain from among a plurality of available domains; and
generating, by the one or more processors and based on the domain, a suggestion prompt configured to be an input to a suggestion large language model (LLM).

14. The method of claim 13, further comprising:
outputting, by the one or more processors, the suggestion prompt to the suggestion LLM; and
receiving, by the one or more processors and from the suggestion LLM, a suggestion configured to be output to an electronic device.

15. The method of claim 14, further comprising:
searching, by the one or more processors, the suggestion for restricted content; and
based on the restricted content, either:
modifying and outputting, by the one or more processors, the suggestion to the electronic device; or
deleting, by the one or more processors, the suggestion.

16. The method of claim 15, further comprising outputting, by the one or more processors, the suggestion to the electronic device, the output of the suggestion comprising one or more of a display output, an audio output, or a tactile output, wherein the interaction data is based on one or more of a display input, a voice input, or a touch input.

17. A non-transitory, computer-readable medium storing instructions that, when accessed by one or more processors, cause the one or more processors to:
receive interaction data, the interaction data comprising a context;
select, based on at least one of the interaction data and the context, a domain from among a plurality of available domains; and
generate, based on at the domain, a suggestion prompt configured to be an input to a suggestion large language model (LLM).

18. The non-transitory, computer-readable medium of claim 17, wherein the instructions further cause the one or more processors to:
output the suggestion prompt to the suggestion LLM; and
receive, from the suggestion LLM, a suggestion configured to be output to an electronic device.

19. The non-transitory, computer-readable medium of claim 18, wherein the instructions further cause the one or more processors to:
search the suggestion for restricted content; and
based on the restricted content, either:
modify and output the suggestion to the electronic device; or
delete the suggestion.

20. The computer program product of claim 19, wherein:
the instructions further cause the one or more processors to output the suggestion to the electronic device, the output of the suggestion comprising one or more of a display output, an audio output, or a tactile output; and
the interaction data is based on one or more of a display input, a voice input, or a touch input.
